(19) United States
(12) Patent Application Publication
(10) Pub. No.: US 2026/0159403 A1
(43) Pub. Date: Jun. 11, 2026

(54) A METHOD FOR PREPARING LITHIUM HEXAFLUOROPHOSPHATE

(71) Applicant: GUJARAT FLUOROCHEMICALS LIMITED, Ranjitnagar, Ghoghamba (IN)

(72) Inventors: V.K. SONI, New Delhi (IN); S.B. GAITONDE, Bhayli TP-1, Vadodara (IN); Bapu V GANGURDE, Manjalpur, Vadodara (IN)

(73) Assignee: GUJARAT FLUOROCHEMICALS LIMITED, Ranjitnagar, Ghoghamba (IN)

(21) Appl. No.: 18/707,378

(22) PCT Filed: Nov. 22, 2022
(86) PCT No.: PCT/EP2022/082772

§ 371 Date: May 3, 2024

(30) Foreign Application Priority Data
Nov. 24, 2021 (IN) 202121054321

(51) Int. Cl. C01D 15/00; C01B 7/19; C01D 15/04

(52) U.S. Cl. CPC C01D 15/005; C01B 7/191; C01D 15/04; C01P 2006/40; C01P 2006/80

(57) ABSTRACT

The present disclosure relates to a process for preparing high purity Lithium Hexafluorophosphate (LiPF6), comprising the steps of: (a) reacting high purified anhydrous hydrogen fluoride (AHF) gas with solid phosphorous pentachloride to produce a mixture of pure phosphorous pentafluoride and hydrogen chloride gas, (b) reacting highly purified lithium fluoride dissolved in AHF solution with phosphorous pentafluoride and hydrogen chloride gas mixture obtained in step (a) to obtain LiPF6 mother liquor, which is LiPF6 dissolved in AHF; crystallizing the LiPF6 from the mother liquor in static crystallizer, separating the mother liquor, drying the product to remove HF; followed by drying and crushing of the crystals of LiPF6 to obtain LiPF6 powder.

### FIELD OF THE INVENTION

The present disclosure relates to a method for preparing Lithium Hexafluorophosphate (LiPF6). More particularly, the present invention relates to a method for preparing high purity LiPF6 useful as an electrolyte in batteries for electric vehicles.

### BACKGROUND OF THE INVENTION

Currently, Lithium-ion batteries are omnipresent in consumer electronic devices such as mobile phones, laptops, watches, earbuds, music systems because of their high energy density compared to other means of storing electrical energy. They also possess good performance under a wide range of temperatures, do not self-discharge, can be quickly recharged, and are light weight.

Apart from consumer electronics, the shift in preference from vehicles using fossil fuels to electric vehicles is fueling a renewed interest in electrical batteries. According to a report published by Statista Research Department dated Jul. 23, 2021; the global demand for batteries is expected to increase from 185 GWh in 2020 to over 2,000 GWh by 2030. The same report predicts that this large increase will mainly be due to the electrification of transport systems which will account for the vast majority of battery demand in 2030 in terms of total energy storage capacity.

Lithium hexafluorophosphate (LiPF6) is a ubiquitous electrolyte salt in lithium-ion batteries. The other electrolyte salts of Li are LiAsF6, LiBF4, LiClO4 and so forth. However, LiPF6 scores over the rest in that it exhibits excellent solubility and high conductivity in various solvents, it is electrically stable, it is environment friendly, it can form suitable Solid Interface Electrolyte (SEI) membrane in electrodes, and it can induce passivation in anode current collectors to prevent their dissolution.

In spite of being ubiquitous electrolyte salt in lithium-ion batteries, current manufacturing processes for high purity LiPF6 cannot meet the requirements of the latest high-strength batteries for use in electric vehicles.

The high-strength batteries are required to fulfil certain conditions, for example, the cycle times should be more than 3,000 times, the battery attenuation rate within seven years cannot be less than 75%, charge and discharge temperatures, battery safety in extreme climates, and electrolyte acidity (in HF concentration), the lower the better.

Conventional preparation of LiPF6, the PF5 gas is passed through a solution of LiF in HF, to form LiPF6. Thereafter, HF is removed and the LiPF6 is crystallized. However, one of the drawbacks of the conventional approach is that large amounts of impurity, in the form of HF and etc. is adsorbed on the surface of LiPF6 crystals. Further, it is very difficult to decrease the amount of such impurities such as HF etc. in LiPF6 without resorting to complex reactions, procedures and additional purification steps.

Impurities in the form of HF etc. causes erosion of the electrodes, which directly affects the capacity and performance of the batteries.

Further, the presence of various metallic impurities such as transition metal impurities is detrimental to the battery performance. For example, the transition metal ions dissolved in the electrolytes might deposit on the anode surface. This might cause decomposition of LiPF6, lithium dendrite growth and cause internal short circuit.

Water is yet another impurity of concern in Lithium-ion batteries. Presence of water negatively affects the battery performance. Water can react with the LiPF6, thereby reducing the capacity of the battery. Presence of water is also implicated in poor cycling performance and loss of active materials. Water can destroy the protective solid electrolyte interface layer and get reduced at the anode to yield H2 gas. Presence of H2 gas increases the internal pressure of the batteries and is an explosion hazard.

Accordingly, there is a need to develop a process of preparing LiPF6 which addresses one or more of the above-mentioned shortcomings.

### SUMMARY OF THE INVENTION

In one aspect, the present invention provides a process of preparing ultra-high purity LiPF6 useful as an electrolyte in batteries, preferably as an electrolyte in batteries for electric vehicles.

In still another aspect, the present invention provides an ultra-high purity LiPF6 with minimum concentration of hydrogen fluoride (HF), preferably less than or equal to 70 ppm.

### BRIEF DESCRIPTION OF THE DRAWINGS

Reference will be made to embodiments of the invention, examples of which may be illustrated in accompanying FIGURES. These FIGURES are intended to be illustrative, not limiting. Although the invention is generally described in the context of these embodiments, it should be understood that it is not intended to limit the scope of the invention to these particular embodiments.

FIG. 1 shows the process flow diagram

### DETAILED DESCRIPTION OF THE INVENTION

It is to be noted that, as used in the specification, the singular forms “a,” “an,” and “the” include plural referents unless the context clearly dictates otherwise. Thus, for example, reference to a composition containing “a compound” includes a mixture of two or more compounds. It should also be noted that the term “or” is generally employed in its sense including “and/or” unless the content clearly dictates otherwise.

The expression of various quantities in terms of “%” or “% w/w” means the percentage by weight of the total solution or composition unless otherwise specified.

The present invention is directed towards a process of preparing ultra-high purity LiPF6 useful as an electrolyte in high strength batteries, preferably as an electrolyte in batteries for electric vehicles.

In one of the embodiments the process of preparing ultra-high purity LiPF6 comprises the following steps:
(a) reacting anhydrous hydrogen fluoride (AHF) gas with solid phosphorous pentachloride to produce high purity phosphorous pentafluoride and hydrogen chloride gas,

PCl5+5AHF→PF5+5HCl;
(b) reacting lithium fluoride dissolved in AHF with phosphorous pentafluoride and hydrogen chloride gas mixture obtained in step (a) to obtain lithium hexafluorophosphate mother liquor, which is LiPF6 dissolved in AHF,

PF5+LiF→LiPF6; and
(c) crystallizing the LiPF6 from the mother liquor and separating the crystallized LiPF6 from the mother liquor,
(d) drying the crystallized LiPF6 to evaporate HF from crystal surface optionally followed by solvent assisted drying, and
(e) crushing the dried crystals of LiPF6 and optionally sieving to obtain LiPF6 powder,
wherein the anhydrous hydrogen fluoride (AHF) gas is purified prior to using it in the process; and wherein the lithium fluoride used in the process is obtained from lithium bicarbonate and hydrogen fluoride.

In an embodiment of the present invention, the purified anhydrous hydrogen fluoride (AHF) gas comprises cationic (metal) impurities less than or equal to 0.1 ppm or anionic impurities less than or equal to 1 ppm or moisture less than or equal to 0.1 ppm or combination thereof.

In yet another embodiment, the purified anhydrous hydrogen fluoride (AHF) gas reacts with PCl5 solid bed reactor with agitation.

In yet another embodiment, the anhydrous hydrogen fluoride (AHF) gas is purified by treatment with fluorine (F2) gas as an oxidizing agent.

In a preferred embodiment, the step (b) is carried out in a reactor, wherein the exhaust gas from the dissolving tank or reactor comprising of PF5, HCl and HF is re-routed into the dissolving tank for the second stage reabsorption.

In yet another embodiment, the step (b) is carried out at a temperature in the range of −5 to 5° C., preferably at 0° C.

In yet another embodiment, the step (b) is carried out in a dissolving tank, wherein the exhaust gas from the dissolving tank comprising PF5, HCl and HF is re-routed into the dissolving tank for reabsorption of PF5.

In a preferred embodiment, the crystallization of LiPF6 in step (c) is performed under vacuum or reduced pressure and cooling between −45 to −5° C., preferably at −35° C. for an extended duration of time.

In yet another embodiment, the crystallization of LiPF6 in step (c) is carried out in a static crystallizer.

An aspect of the present invention provides a design of special crystallizer structure, a three-in-one device with crystallization, filtration, and primary drying function simplifies the traditional three chemical processes in one equipment. This greatly reduces the risk of multiple movements of HF reactive substances, and associated risks faced by operators handling the operation.

In a preferred embodiment, the static crystallizer takes a single turn in about 48 hours so to allow the crystals to grow slowly to a large size and minimize surface area for HF adsorption.

In another preferred embodiment, the mother liquor in step (c) is re-used by adding LiF at −5 to 5° C., preferably at 0° C.

In a preferred embodiment, the drying of the crystallized LiPF6 in step (d) is done by hot water circulation in the dryer jacket, preferably at 60 to 70° C. under vacuum for about 6 hours.

In yet another embodiment, the drying of crystallized LiPF6 in step (d) is followed by solvent assisted drying preferably with solvents such as methanol, ether, dichloromethane.

Another aspect of the method is to use a mesh size so as to have lower HF adsorbed crystals of larger size sifted out as the final product. The smaller crystals with higher adsorbed HF are re-circulated through the mother liquor. This reduces the total concentration of HF in the finished product, and the recovery of LiPF6 crystals reduces production costs.

In a preferred embodiment, sieving of dried crystals of LiPF6 is done through mesh size of less than or equal to 90.

In another embodiment, the lithium fluoride used in the process is obtained from the steps of:
(1) treating Lithium carbonate with carbon dioxide to obtain Lithium bicarbonate,

Li2CO3+H2O+CO2→2LiHCO3;
(2) reacting the Lithium bicarbonate with ultra-pure hydrogen fluoride to obtain lithium fluoride,

LiHCO3+HF→LiF+CO2+H2O; and
(3) drying and crushing the lithium fluoride.

In a preferred embodiment, the CO2 is recycled and reused.

In another embodiment, the exhaust from the reactor comprising PF5, HCl, oxides of phosphorous and HF is re-guided into the mother liquor for the second stage reabsorption process, which improves the overall efficiency of the process.

In another embodiment, the gaseous exhaust from the mother liquor tank comprising HCl and HF is re-guided to a recovery system, which improves the overall efficiency of the process.

Another aspect of the present invention relates to an ultra-high purity lithium hexafluorophosphate (LiPF6) with a purity of at least 99.97%.

In a preferred embodiment of the present invention the ultra-high purity lithium hexafluorophosphate (LiPF6) comprises
insoluble material in an amount less than or equal to 200 ppm, or
metallic impurities—each of which is present in an amount less than or equal to 1 ppm, or
hydrogen fluoride in an amount less than or equal to 70 ppm, or
sulfate ions (SO42−) in an amount less than or equal to 10 ppm, or
nitrate ions (NO3−) in an amount less than or equal to 5 ppm, or
chloride ions (Cl−) in an amount less than or equal to 5 ppm, or
water/moisture in an amount less than or equal to 10 ppm, or combination thereof.

In a preferred embodiment of the present invention the ultra-high purity lithium hexafluorophosphate (LiPF6) comprises metallic impurities as follows

| | |
|---|---|
| Na | ≤1.0 ppm |
| K | ≤1.0 ppm |
| Fe | ≤1.0 ppm |
| Zn | ≤1.0 ppm |
| Ni | ≤1.0 ppm |
| Mg | ≤1.0 ppm |
| Ca | ≤1.0 ppm |
| Pb | ≤1.0 ppm |
| Cr | ≤1.0 ppm |

According to the method of the present invention, the battery grade high purity PCl5 is obtained from commercial sources. In step (a) the gaseous high purity anhydrous hydrogen fluoride (AHF) reacts with the solid phosphorus pentachloride (PCl5) to produce phosphorus pentafluoride (PF5) and hydrogen chloride.

Impurities in LiPF6 are a direct consequence of the impurities present in the main raw materials, i.e., AHF and LiF. Hence, as discussed below, the AHF and LiF used in the present invention are purified to minimize moisture, insoluble and metallic impurities. In other words, only high purity AHF and LiF are used in the present invention.

Usually, PCl5 is dissolved in AHF to prepare PF5. This results in impurities such as AsF5, BF4 etc. However, in the present invention, gaseous AHF reacts with solid PCl5 in a packed bed reactor. Thereafter, the resulting PF5 is passed through a filter to remove any PCl5 grains that might be adrift in the gas stream, to obtain a high purity PF5 gas. Accordingly, the process by virtue of being carried out in a packed bed reactor with high purity gaseous AHF eliminates or minimizes impurities and water in the PF5 gas.

In step (b), PF5 produced in step (a) enters a reactor—2 wherein it reacts with the LiF dissolved in AHF. This results in the formation of LiPF6 dissolved in AHF, also called as the mother liquor. Preferably, step (b) is carried out at a temperature in the range of −5 to 5° C., more preferably at 0° C.

The exhaust from the reactor comprising PF5, HCl, oxides of phosphorous and HF is re-guided into the mother liquor for the second stage reabsorption process, which improves the overall efficiency of the reaction, particularly, by improving the recovery efficiency of PF5.

Crystallization is carried out from the mother liquor in a static crystallization tank, wherein the mother liquor is cooled. The mother liquor is cooled over an extended period.

The static crystallizer used in the present invention takes a single turn in 48 hours. The LiPF6 crystals are allowed to grow slowly to a large size. Larger size of the crystals of LiPF6 translates into lesser surface area for HF to get adsorbed onto, resulting in LiPF6 with minimum HF content. The crystals are separated by passing through mesh sieves. The separated larger crystals of LiPF6 are crushed and dried to obtain high purity powdered LiPF6 at temperatures of 60-70° C., under vacuum for about 6 hours to drive out maximum HF.

The smaller crystals of LiPF6 are re-used by adding a certain amount of lithium fluoride added into the mother liquor at −5 to 5° C., preferably at 0° C. and the process repeated to get larger sized crystals.

If a regular rotating crystallizer is used instead of the static crystallizer, it will give rise to smaller crystals with HF content in the range 150-250 ppm. If higher temperatures, are used for drying, there is decomposition and generation of HF from the LiPF6 crystals.

### Example

Discussed below are some representative embodiments of the present invention. The invention in its broader aspects is not limited to the specific details and representative methods. An illustrative example is described in this section in connection with the embodiments and methods provided.

The following example is illustrative of the invention but not limitative of the scope thereof.

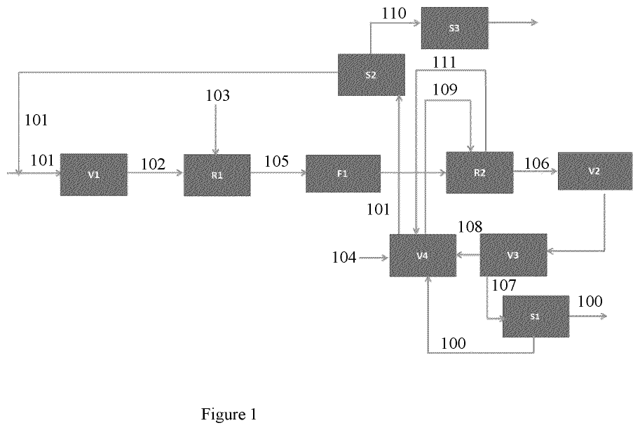

FIG. 1 illustrates the process flow diagram for preparing LiPF6 according to an embodiment of the present disclosure. According to the process HF solution (101) is passed through a vaporizer (V1) to convert HF into a gaseous state (102). The HF gaseous state (102) obtained from vaporizer (V1) is reacted with PCL5 powder (103) in first reactor (R1) to obtain intermediate products PF5, HCl (g) and unreacted HF (105). The intermediate products (105) are passed through a filter (F1) and sent to a second reactor (R2) to obtain a product solution (106) comprising LiPF6 and HF solution which is passed onto a hold-up tank (V2). The product solution (106) from the hold-up tank (V2) is passed onto the crystallizer (V3) wherein the product LiPF6 (107) is recovered, and mother-liquid (108) is separated. The product (107) is passed through sieves (S1) to obtain the desired size product LiPF6 and the remaining is recycled to the mother-liquid tank (V4). The mother-liquid (108) comprising LiF and HF solution is sent to a mother-liquid tank (V4) wherein HF solution and LiF (104) are further added and the treated mother-liquid (109) is recycled to the second reactor (R2) to obtain a product solution (106) comprising LiPF6 and HF solution. The vent gases (111) from the mother-liquid tank (V4) are sent to a recovery system (S2) to reuse and recycle HF gases (101) and the unrecovered vent gases (110) are sent to 3-stage scrubber (S3) for disposal.

Impurities in LiPF6 are a direct consequence of the impurities present in the main raw materials, i.e., AHF and LiF. Hence, as discussed below, the AHF and LiF used in the present invention are purified to minimize moisture, insoluble and metallic impurities. In other words, only high purity AHF and LiF are used in the present invention.

In commercial HF, metals such as Fe, Ca, Mg react with active PF5 in synthesis reaction vessel to form FeF3, CaF2, MgF2 which increase the impurities in LiPF6 crystal. Accordingly, the AHF used in the present invention is purified prior to using it in the method of the present invention.

Commercial AHF is purified by treatment with fluorine (F2) as an oxidizing agent to fluorinate AHF impurities to remove most metals including Arsenic. If AHF is not purified by reacting with F2, gaseous impurities such as metallic fluorides, AsF5 and BF4 might contaminate the mother liquor. Use of purified AHF in the present invention, further minimizes impurities in the LiPF6 crystals of the present invention.

Example-1: Preparation of high purity AHF: Pure Fluorine gas is purged into commercial AHF at a pressure of 0.2 kg/cm2 for 3 min at temperature of 25° C. in a reaction vessel. After the impurities are precipitated as fluorides, the pure AIF is transferred to distillation column from the reaction vessel. The impurity levels of commercial vs purified AHF are provided below:

| | | |
|---|---|---|
| | Commercial | Purified |
| Impurity | AHF | AHF |

| | | | | |
|---|---|---|---|---|
| Moisture | ≤250 | ppm | ≤0.1 | ppm |
| Fe | ≤3 | ppm | ≤0.1 | ppm |
| Ca | ≤3 | ppm | ≤0.1 | ppm |
| K | ≤3 | ppm | ≤0.1 | ppm |
| Na | ≤3 | ppm | ≤0.1 | ppm |
| Ni | ≤3 | ppm | ≤0.1 | ppm |
| Pb | ≤3 | ppm | ≤0.1 | ppm |
| Zn | ≤3 | ppm | ≤0.1 | ppm |
| Cr | ≤3 | ppm | ≤0.1 | ppm |
| Cu | ≤3 | ppm | ≤0.1 | ppm |
| Mg | ≤3 | ppm | ≤0.1 | ppm |
| Al | ≤3 | ppm | ≤0.1 | ppm |
| As | ≤3 | ppm | ≤0.1 | ppm |
| B | ≤3 | ppm | ≤0.1 | ppm |
| H2SiF6 | ≤250 | ppm | ≤10 | ppm |
| H2SO4 | ≤150 | ppm | ≤3 | ppm |

Insoluble impurities such as silicates, fluorosilicates and sulphates of metals, such as Fe, Ca, K, Na, Ni, Pb, Zn, Cr, Mg, Cu, and Al are present in LiF. Some metals do not dissolve in AHF and remain as solid particles. Some react with AHF to form fluoride material, for example, FeF3, NaF, CaF2, MgF2. The fluoride material, in these cases, precipitates as a solid at the bottom of the crystallizer and stays with LiPF6 crystals. This is the main cause of impurities in LiPF6. These insoluble impurities end up in the LiPF6 thereby increasing the combined levels of Ca, Mg, Na, K, etc above 100 ppm. Accordingly, in order to produce high purity LiPF6, the LiF used in the process must be free of said metallic impurities.

Example-2: Preparation of high purity LiF: 3.9 kgs of commercial Li2CO3 is mixed with 78 liters of pure deionized water to prepare slurry in a 100 L reactor. Pure carbon dioxide gas (purity 99%) is passed through the slurry in the reactor at a pressure of 3 kg/cm2 for 6 hours wherein soluble LiHCO3 is formed. The insoluble impurities are filtered off by passing the LiHCO3 solution through two series of cartridge filters. The soluble impurities are then removed by passing the LiHCO3 solution through cation exchange resin columns. 84 kgs of the purified LiHCO3 solution is then reacted with 425 liters of 50% HF to yield LiF. The LiF so formed, is filtered and dried by evaporating water at 130° C.

The impurity levels of the purified LiF are provided below:

| | | |
|---|---|---|
| | Commercial | Purified |
| Impurity | Li2CO3 | LiF |

| | | | | |
|---|---|---|---|---|
| Fe | 8 | ppm | 1 | ppm |
| Ca | 53 | ppm | 2 | ppm |
| K | 8 | ppm | 1 | ppm |
| Na | 45 | ppm | 10 | ppm |
| Ni | 3 | ppm | 1 | ppm |
| Pb | 5 | ppm | 1 | ppm |
| Zn | 1 | ppm | 0.5 | ppm |
| Cr | 0.5 | ppm | 0.5 | ppm |
| Cu | 5 | ppm | 1 | ppm |
| Mg | 45 | ppm | 2 | ppm |
| Al | 7 | ppm | 1 | ppm |
| As | 3 | ppm | 1 | ppm |
| B | 3 | ppm | 2 | ppm |

Thus, in order to improve the purity of LiF, Lithium carbonate is treated with CO2 gas to generate water-soluble Lithium bicarbonate (LiHCO3). This process removes heavy metal ions and insoluble impurities with water. The insoluble impurities are filtered with two series of fine filters. Those ions dissolved in water are removed by the cation exchange. The resulting LiHCO3 is substantially free of any insoluble and heavy metal impurities. The CO2 released during the reaction is re-used to make the process more efficient.

Example-3: Preparation of LiPF6—930 grams of the high purity AHF produced as above, is added to 1500 grams of solid PCl5 maintained at a temperature of 40 to 80° C. The mixture of PF5+HCl+HF generated from this reaction is fed into a solution of LiF+AHF (171 grams+7800 grams AHF) at −5 to 5° C. to produce 1 kg of LiPF6 in AHF solvent. LiPF6 is crystallized from this solution, filtered and dried to get the pure product.

The impurity levels of ultra-high purity LiPF6 according to the present process are provided below:

| | Ultra-high |
|---|---|
| Impurity | purity LiPF6 |
| Fe | ≤1.0 ppm |
| Ca | ≤1.0 ppm |
| K | ≤1.0 ppm |
| Na | ≤1.0 ppm |
| Ni | ≤1.0 ppm |
| Pb | ≤1.0 ppm |
| Zn | ≤1.0 ppm |
| Cr | ≤1.0 ppm |
| Cu | ≤1.0 ppm |
| Mg | ≤1.0 ppm |

The LiPF6 obtained by the process described hereinabove comprises insoluble material in an amount less than or equal to 200 ppm, and/or comprises metallic impurities—each of which is present in an amount less than or equal to 1 ppm, and/or comprises HF in an amount less than or equal to 70 ppm, and/or comprises SO42− in an amount less than or equal to 10 ppm, and/or comprises NO3− in an amount less than or equal to 5 ppm, and/or comprises Cl− in an amount less than or equal to 5 ppm and/or comprises water in an amount less than or equal to 10 ppm or combination thereof.

The purity of LiPF6 obtained by the process of the present invention is at least 99.97%.

In the absence of the AHF purification process, preparation of high purity LiF and the crystallization and drying steps, the metallic impurities get carried over and become a part of the final product i.e., LiPF6. The LiPF6 impurity profile then has a total metallic impurity of 30-80 ppm instead of less than or equal to 1 ppm.

Further, it can be seen that the metallic impurities for the ultra-high purity LiPF6 according to the present invention is significantly lower than the battery grade LiPF6 commercially available from SIGMA-ALDRICH-MERCK or NANOSHEL shown in the Table below. It can be concluded that ultra-high purity LiPF6 produced by the process of the present invention disclosure is superior.

| Battery | Metallic | |
|---|---|---|
| grade LiPF6 | impurities | |
| SIGMA- | ≤100 | ppm |
| ALDRICH-MERCK | | |
| NANOSHEL | ≤80 | ppm |

The foregoing description of the invention has been set merely to illustrate the invention and is not intended to be limiting. Since the modifications of the disclosed embodiments incorporating the spirit and substance of the invention may occur to the person skilled in the art, the invention should be construed to include everything within the scope of the disclosure.

1. A method for preparing ultra-high purity lithium hexafluorophosphate (LiPF₆), comprising the following steps:
(a) reacting anhydrous hydrogen fluoride (AHF) gas with solid phosphorous pentachloride (PCl₅) to produce a high purity phosphorous pentafluoride (PF₅) and hydrogen chloride gas (HCl) mixture;
(b) reacting lithium fluoride (LiF) dissolved in AHF with the PF₅ and HCl gas mixture obtained in step (a) to obtain a mother liquor comprising lithium hexafluorophosphate (LiPF₆) dissolved in AHF; and
(c) crystallizing the LiPF₆ from the mother liquor and separating the crystallized LiPF₆ from the mother liquor;
(d) drying the crystallized LiPF₆ to evaporate hydrogen fluoride (HF) from crystal surface followed by solvent assisted drying, and
(e) crushing the dried crystals of LiPF₆;
wherein the AHF gas is purified prior to using the AHF gas in the method; and
wherein the LiF used in the method is obtained from lithium bicarbonate (LiHCO₃) and HF.

2. The method as claimed in claim 1, wherein the purified AHF gas comprises cationic metal impurities less than or equal to 0.1 ppm or anionic impurities less than or equal to 1 ppm, or moisture less than or equal to 0.1 ppm, or combinations thereof.

3. The method as claimed in claim 1, wherein the purified AHF gas reacts with a PCl₅ solid bed.

4. The method as claimed in claim 1, wherein the AHF gas is purified by treatment with pure fluorine (F₂) or mixtures of fluorine (F₂) and nitrogen (N₂) as an oxidizing agent.

5. The method as claimed in claim 1, wherein step (b) is carried out in a dissolving tank or reactor; wherein an exhaust gas from the dissolving tank or reactor comprises PF₅, HCl and HF; and wherein the exhaust gas is re-routed into the dissolving tank for a second stage reabsorption.

6. The method as claimed in claim 1, wherein step (b) is carried out at a temperature in a range of −5 to 5° C.

7. The method as claimed in claim 1, wherein the crystallization of LiPF₆ in step (c) is performed under vacuum or a reduced pressure and is cooled to between −45 to −5° C. for about 24-36 hours.

8. The method as claimed in claim 1, wherein the crystallization of LiPF₆ in step (c) is carried out in a static crystallizer.

9. The method as claimed in claim 8, wherein the static crystallizer takes a single turn in about 48 hours so to allow the crystals to grow slowly for maximizing size of the grown crystals to minimize a total surface area of the grown crystals suitable for HF adsorption.

10. The method as claimed in claim 1, wherein the mother liquor in step (c) is re-used by adding LiF at −5 to 5° C.

11. The method as claimed in claim 1, wherein the drying of the crystallized LiPF₆ in step (d) is done by hot water circulation in a dryer jacket under vacuum for about 6 hours.

12. The method as claimed in claim 1, wherein the drying of the crystallized LiPF₆ in step (d) is followed by solvent assisted drying.

13. The method as claimed in claim 1, further comprising, after step (e), sieving the crushed crystals of LiPF₆ to obtain LiPF₆ powder, and wherein the sieving is done through a mesh size of less than or equal to 90.

14. The method as claimed in claim 1, wherein the LiF used in the method is obtained from steps of:
(1) treating Lithium carbonate (Li₂CO₃) with carbon dioxide (CO₂) to obtain LiHCO₃;
(2) reacting the LiHCO₃ with ultra-pure HF to obtain LiF;
and
(3) drying and crushing the LiF.

15. The method as claimed in claim 14, further comprising recycling and reusing the CO₂.

16. The method as claimed in claim 1, wherein an exhaust from the reactor comprises PF5, HCl, oxides of phosphorous and HF, and wherein the exhaust is re-guided into the mother liquor for a second stage reabsorption process.

17. The method as claimed in claim 1, wherein a gaseous exhaust from the mother liquor tank comprises HCl and HF; and wherein the gaseous exhaust is re-guided to a recovery system.

18. An ultra-high purity lithium hexafluorophosphate (LiPF₆) with a purity of at least 99.97%.

19. The ultra-high purity LiPF₆ as claimed in claim 18, comprising:
insoluble material in an amount less than or equal to 200 ppm; or
metallic impurities, wherein each metallic impurity is present in an amount less than or equal to 1 ppm; or
hydrogen fluoride (HF) in an amount less than or equal to 70 ppm; or
sulfate ions (SO₄²⁻) in an amount less than or equal to 10 ppm; or
nitrate ions (NO³⁻) in an amount less than or equal to 5 ppm; or
chloride ions (Cl⁻) in an amount less than or equal to 5 ppm; or
water/moisture in an amount less than or equal to 10 ppm, or combination thereof.

20. The ultra-high purity LiPF₆ as claimed in claim 18, comprising metallic impurities as follows:

| | |
|---|---|
| Na | ≤1.0 ppm |
| K | ≤1.0 ppm |
| Fe | ≤1.0 ppm |
| Zn | ≤1.0 ppm |
| Ni | ≤1.0 ppm |
| Mg | ≤1.0 ppm |
| Ca | ≤1.0 ppm |
| Pb | ≤1.0 ppm |
| Cr | ≤1.0 ppm |
